(19) United States
(12) Patent Application Publication
(10) Pub. No.: US 2022/0251944 A1
(43) Pub. Date: Aug. 11, 2022

(54) Utilizing Wastes in Water Systems as Oil Reservoir Tracers

(71) Applicant: Saudi Arabian Oil Company, Dhahran (SA)

(72) Inventors: Hsieh Chen, Cambridge, MA (US); Martin E. Poitzsch, Northumberland, NH (US); Hooisweng Ow, Woburn, MA (US); Wei Wang, Quincy, MA (US)

(21) Appl. No.: 17/573,074

(22) Filed: Jan. 11, 2022

Related U.S. Application Data
(60) Provisional application No. 63/146,315, filed on Feb. 5, 2021.

(51) Int. Cl. E21B 47/11; C09K 8/588

(52) U.S. Cl. CPC E21B 47/11; C09K 8/588

(57) ABSTRACT

A technique of utilizing waste as an interwell tracer. The waste includes pharmaceutical, personal care product (PPCP) waste or nanoplastic (NP) waste, or both. The system and method includes injecting an injection fluid including water and the waste at an injection well into a subterranean formation, producing produced fluid including water at a production well from the subterranean formation, measuring concentration of the waste in the produced fluid, and comparing the concentration of the waste in the produced fluid with the concentration of the waste in the injection fluid.

### CROSS-REFERENCE TO RELATED APPLICATIONS

This application claims the benefit of U.S. Provisional Application Ser. No. 61/146,315, filed Feb. 5, 2021, the entire contents of which are incorporated herein by reference in its entirety.

### TECHNICAL FIELD

This disclosure relates to interwell tracing in a subterranean formation.

### BACKGROUND

Interwell tracers may be applied to characterize a hydrocarbon reservoir in a subterranean formation in the Earth crust. Reservoir characterization may advance efforts to increase recovery of hydrocarbons (e.g., crude oil, natural gas, etc.) from the reservoir. Interwell tracer tests can increase understanding of the reservoir architecture (e.g., reservoir flow paths and barriers), increase understanding of reservoir flow performance (and reservoir properties) that influence displacement of hydrocarbon (oil and/or gas) and water, and reduce uncertainties attributed to well-to-well communications, vertical flow, and horizontal flow. Such understanding can contribute to strategies to increase production of hydrocarbons from the reservoir. Assessments via interwell tracers can include to evaluate injector-to-producer flow connections, water channeling (e.g., in a high water cut field), and enhanced oil recovery (EOR) studies including to assess sweep efficiency (e.g., in an EOR pilot test). EOR can involve, for example, waterflooding including with polymer or chemicals. EOR (tertiary oil recovery) is a way to further increase oil production. EOR generally increases the amount of crude oil or natural gas that can be extracted from a reservoir or geological formation. There are different EOR or tertiary techniques.

### SUMMARY

An aspect relates to a method of utilizing waste as an interwell tracer. The waste includes pharmaceutical, personal care product (PPCP) waste or nanoplastic (NP) waste, or both. The method includes determining concentration of the waste in injection fluid. The injection fluid includes water. The method includes injecting the injection fluid at an injection well into a subterranean formation. The method includes producing produced fluid including water at a production well from the subterranean formation. The method includes measuring concentration of the waste in the produced fluid, and comparing the concentration of the waste in the produced fluid with the concentration of the waste in the injection fluid.

Another aspect relates to a method of utilizing waste as an interwell tracer. The waste includes PPCP or NP, or both. The method includes measuring concentration of the waste in injection water, and injecting the injection water into a subterranean formation at an injection well. The method includes producing water from the subterranean formation at a production well, and measuring concentration of the waste in the water as produced. The method includes correlating the concentration of the waste in the water as produced with the concentration of the waste in the injection water.

The details of one or more implementations are set forth in the accompanying drawings and the description below. Other features and advantages will be apparent from the description and drawings, and from the claims.

### BRIEF DESCRIPTION OF DRAWINGS

FIG. 1 is a block flow diagram of a workflow for utilizing wastes in water as interwell tracers.

FIGS. 2A and 2B are plots related to ibuprofen decay.

FIGS. 3A and 3B are a sequence diagram of reaction mechanisms for the abiotic degradation of ibuprofen in the presence of kaolinite clay and light.

FIG. 4 is a block flow diagram of a workflow for utilizing wastes in water as interwell tracers.

FIG. 5 is a diagram of an injection well.

FIG. 6 is a diagram of a production well.

FIG. 7 is a block flow diagram of a method of utilizing waste as an interwell tracer.

### DETAILED DESCRIPTION

Some aspects of the present disclosure are directed to utilizing wastes in water systems as interwell tracers in subterranean formations with oil reservoirs. The wastes utilized as the interwell tracers may be pharmaceutical, personal care product (PPCP) wastes and nanoplastic (NP) wastes, and the like.

A purpose of interwell tracer tests in oil reservoirs may be to monitor qualitatively and quantitatively the fluid connections between injection wells and production wells, as well as to map the flow field. A tracer in fluid injected at an injection well may be observed in the surrounding production wells. Tracer response may be utilized to describe the flow pattern and obtain better understanding of the reservoir, which can help to advance oil recovery. Tracers are means of tracking the movement of injected fluids in a reservoir. Tracers may be classified as passive or active. Utilization of an interwell tracer may be a technique to obtain data to facilitate analysis of injection and production options. As indicated, interwell tracers may facilitate to map well-to-well communication and reservoir heterogeneity or homogeneity. Information gained from employment of tracers can be obtained by observing breakthrough and interwell communication. Tracer implementations may provide tracer-response curves that may be evaluated further to obtain additional information, such as by fitting numerical simulation or reservoir models to the observed response curves.

Hydrocarbon-bearing reservoirs may be interconnected subterranean systems. Understanding the connectivity between injection wells and production wells can be a factor in reservoir management including, for example, with respect to both (1) implementing EOR applications for increased oil production and (2) addressing unexpected early water breakthrough that can reduce oil production, and so on. Understanding subsurface reservoir fluid flows can be beneficial for reservoir management and planning, such as in-field drilling, production optimization, conformance control, etc.

One way to understand reservoir fluid flows is with interwell tracers, which can be foreign chemicals injected from injectors (injection wells) and monitored for their breakthrough from nearby producers (producer wells). Interwell tracers injected at different wells may be extracted from a single producer or multiple producers. There are many examples of interwell tracer applications. For instance, interwell tracing can be for the sake of increasing the oil recovery factor in large waterflooded reservoirs through improved optimization of the water injection for oil production.

Instead of injecting foreign chemicals with the fluid (e.g., water) as a tracer, the intrinsic properties of the injection fluids can be utilized for tracing reservoir fluid flows. For example, the salt concentration (salinity) differences between injection fluids and connate fluids can be relied on to monitor waterflooding.

In embodiments herein, the persistent nature of manmade pollutants already present in injection fluids (e.g. seawater, groundwater, etc.) are exploited as tracers. The concentration profiles of these pollutants may provide for utilization of pollutants as tracers to understand the reservoir fluid flows. For the past decades, the concentrations of pollutants (wastes), such as PPCP wastes (e.g., ibuprofen, salicylic acid, etc.) have increased in water systems including surface water (e.g. rivers, lakes, etc.), groundwater, and seawater. Seawater can be considered surface water. These PPCP wastes generally are not completely removed by conventional physical and chemical wastewater treatment techniques.

Synthetic polymers are a significant class of materials of the 21st century and can impact our society and daily life. Growing production and applications of polymer materials can lead to an increase of plastic waste including significant amount of plastic waste emitted into the aqueous environment. Small particles of plastic pollution, e.g., termed “microplastics” or “nanoplastics” can form through fragmentation of large pieces of polymer materials. The particle size of these microplastics (MP) may be, for example, in the range of 100 nanometers (nm) to 5 millimeters (mm). The particles size of nanoplastics (NP) may be, for example, less than 100 nm. Pollution in water that is plastic debris including plastic fragments (e.g., MP and NP) can be a major water-quality issue in fresh and marine water systems.

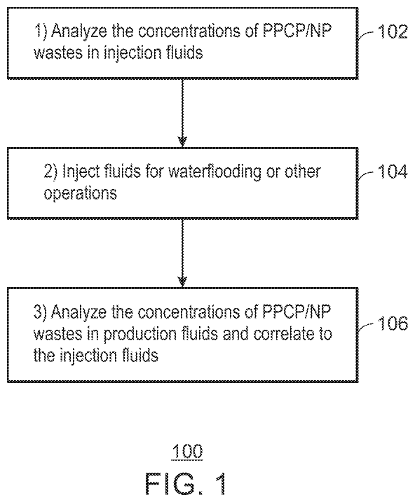

In certain embodiments of the present techniques, the concentrations of PPCP or nanoplastics can be first analyzed in injection fluids (e.g., primarily water) and then monitored for breakthroughs from nearby producers to understand subsurface reservoir fluid flows. See, for example, FIG. 1. Thus, these wastes already existing in the injected water are utilized as an interwell tracer.

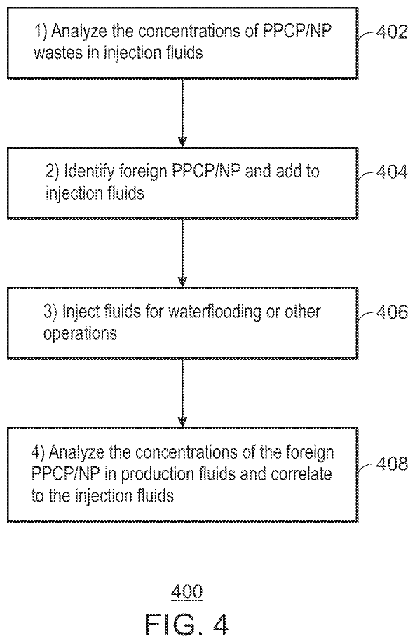

In an alternative or complementary approach, instead of relying on the PPCP/NP already existing in the injection fluids, pulses of high concentrations of foreign PPCP/NP (additional PPCP/NP not originally in the fluids) as interwell tracers may be co-injected with the injection fluid to tag the injection fluid. See, for example, FIG. 4. The high concentration may be, for example, 15 kilograms of PPCP/NP mixed per 500 liters of water giving 25,000 part per million (ppm) of PPCP/NP in the injection fluid. The sources of the additional (foreign) PPCP/NP may be mass produced or purchased from contracted pharma companies, or may be collected from foreign wastewater treatment plants, and so forth. A benefit of this approach may be to further tag the injection fluids from the same source (having PPCP/NP profiles) for injections in different injectors. Relatively short pulses (e.g., injected in a single day) of PPCP/NP concentrated in the injection fluid may be detected from the producers (production wells) more easily in some implementations. The concentrations of the foreign PPCP/NP as added to the injection fluid may be significantly greater than typical as existing in water systems so to facilitate detection in the produced fluids. Moreover, some common PPCP/NP molecules can be readily obtained and may be relatively inexpensive including in large quantities. For PPCP/NP as good tracers with desired properties, the material costs can be relatively low in certain instances for utilizing these molecules.

In oil production operations such as waterflooding in enhanced oil recovery (EOR), a relatively large quantity of water is injected into the subterranean formation via injectors (injection wells) and may be produced from the subterranean formation via nearby producers (production wells). The injection fluids may include, for example, seawater, groundwater, river water, or lake water. Such water can include PPCPs.

For instance, PPCPs in groundwater can include antibiotics (e.g., sulfamethoxazole, sulfamethazine, ofloxacin, norfloxacin, azithromycin, trimethoprim), anti-inflammatories (e.g., ibuprofen, naproxen, diclofenac, salicylic acid), lipid regulators (e.g., bezafibrate, gemfibrozil, clofibric acid), psychiatric drugs (e.g., carbamazepine, diazepam, prim idone), stimulants (e.g., caffeine), insect repellants (e.g., diethyltoluamide [DEET]), x-ray contrast media (e.g., lopam idol), beta-blockers (e.g., propranolol, metoprolol), musks (e.g., galazolide, tonalide), and sunscreen agents (e.g., octocrylene, ethylhexyl methoxycinnamate). Depending on the particular PPCP waste and particular water source (water system), example concentrations of these PPCP wastes in the water can range be as low as 0.1 nanogram per liter (ng/L) or as high as 16,000 ng/L. For a discussion of this list of PPCPs in groundwater, see Sui et al., Occurrence, sources and fate of pharmaceuticals and personal care products in the groundwater: A review, Emerging Contaminants, vol. 1, issue 1, pp. 14-24 (November 2015).

Example PPCP wastes in seawater, such as in the San Francisco Bay, Pacific Ocean (USA), Mediterranean Sea (Israel), and/or Baltic Sea (Spain), can include 1H-benotriazole, atenolol, atrazine, benzoylecgonine, bezafibrate, caffeine, carbamazepine, cetirizine, citalopram, clarithromycin, desethylatrazine, diclofenac, diuron, erythromycin, fluoxetine, gembifrozil, haloperidol, ibuprofen, iohexol, iopam idol, isoproturon, loratadine, mecoprop, paracetamol, paraxanthine, prim idone, roxithromycin, sotabol, sulfamethoxazole, tamoxifen, terbuthylazine, theobromine, theophylline, and tolytriazole. For a discussion of this list including concentration and method quantization limit (MQL), see Nödler, et al., Polar organic micropollutants in the coastal environment of different marine systems, Marine Pollution Bulletin, vol. 85, issue 1, pp. 50-59 (August 2014).

Nanoplastic wastes can include synthetic polymers, such as polyethylene terephthalate (PET), polyethylene (PE) generally, high-density polyethylene (HDPE), low-density polyethylene (LDPE), polyvinyl chloride (PVC), polypropylene (PP), polystyrene (PS), and polyurethane, and the like. Additives in these plastics that are nanoplastic wastes can include, for example, bisphenol A (BPA), phthalate acid esters (PAE), perfluoroalkyl substances (PFAS), nonylphenol (NP), and brominated flame retardants (BFR).

FIG. 1 is a workflow 100 for utilizing PPCP/NP wastes (pollutants, contaminants) in water as interwell tracers. As used herein, the phrase PPCP/NP wastes can mean PPCP wastes or NP wastes, or both. The term PPCP/NP can mean PPCP or NP, or both.

At block 102, the workflow includes analyzing (measuring) concentrations of PPCP/NP wastes in injection fluids. The injection fluids are fluids for injection through a wellbore into a subterranean formation. The wellbore may be of an injection well or of a well being utilized for injection. The injection fluids may be primarily water that may include seawater, groundwater, river water, or other water. In examples, the injection fluids may be fluids injected for waterflooding in enhanced oil recovery (EOR). PPCP waste molecules can be typically stable and many may generally not degrade (or not degrade significantly) through hydrocarbon reservoirs, which may make PPCP waste molecules beneficial as interwell tracers. The detection and analysis of PPCP waste molecules in fluids (e.g., water) may be performed utilizing standard analytical chemistry techniques, such as solid phase extractions (SPE), gas chromatography-mass spectrometry (GC-MS), high-performance liquid chromatography (HPLC), etc.

Bio-inspired high-selectivity binding, utilizing platforms such as molecularly imprinted polymers (MIPs), can also be employed as high-specificity sorbate to pre-concentrate these compounds. MIPs is a technique that creates analyte-specific template shaped “cavities” with predetermined selectivity and high affinity to accomplish “lock and key” recognition for the analytes of interest. A sorbate polymer imprinted with selectivity and affinity for PPCP waste molecules templates may improve recovery of these molecules from the produced water for detection.

For the nanoplastic pollution, the nanoplastics may generally be stable in fresh surface water and seawater at environmental conditions. Indeed, full degradation when desired can be a challenge. Thus, the nanoplastics may be applicable for tracing water flow in a hydrocarbon (e.g., oil) reservoir in a subterranean formation. The nanoplastic pollutants (e.g., see NP list above) are typically man-made polymer components and can be differentiated from natural crude-oil components. The prevalence of nanoplastic pollution has prompted sampling and analysis of the environmental samples to understand the NP pollution. Protocols have been developed to collect and separate the microplastic and NP particles from water. Analytical techniques utilized to identify the NP include, for example, vibrational spectroscopy, scanning electron microscopy (SEM), transmission electron microscope (TEM), energy-dispersive X-ray spectroscopy (EDS), and dynamic light scattering (DLS), etc. The vibrational spectroscopy can include, for example, Fourier-transform infrared (FTIR) spectroscopy or Raman spectroscopy. Techniques to identify and quantify concentration of NP in water can involve ultraviolet-visible (UV-VIS) spectroscopy, pyrolysis mass spectrometry (Pyrolysis-MS), field flow fractionation (FFF), and so on. Separation and analysis of the microplastics and NP in complex environmental wastewater have been implemented. The separation can involve, for example, active density separation (centrifugation) and surface-interaction-based separations. Existing protocols and techniques can be adopted to sample and analyze the NP tracers in injection water samples and produced water samples for oil reservoirs. Environmental scientists and analytical chemists have developed techniques with increased sensitivity for the analysis of PPCP/NP, which benefit present embodiments herein of utilizing PPCP/NP as interwell tracers.

At block 104, the workflow includes injecting the injection fluid into the subterranean formation, such as at an injection well. The injection fluid may be primarily water and have PPCP/NP waste as identified (and their concentration measured) in block 102. The injection fluid may be injected for an interwell tracer test. The injection fluid may be injected for waterflooding or other operations. A benefit of implementations of the present workflow 100 is that there can be little or no interruption to field operations. For instance, the injection fluid can be injected for waterflooding, and the PPCP/NP in the injection fluid utilized as interwell tracers for tracer testing contemporaneous with the waterflooding. After the injection fluid samples are initially collected and analyzed for composition (e.g., compositional analysis) in block 102, the fluids can be injected to reservoirs (subterranean formation) congruent with the normal or typical oilfield operations, such as in a waterflooding operation.

At block 106, the workflow includes analyzing concentrations of PPCP/NP wastes in production fluids and such correlated to the concentrations of PPCP/NP wastes in the injection fluids. The detection of PPCP/NP wastes in the produced fluids may be determined via the analytical chemistry techniques for detection discussed above with respect to block 102 for the injection fluids.

Produced water (e.g., samples collected at discharge of production well) may be analyzed to determine traces (identity and concentrations) of PPCP/NP wastes and this correlated with the identification and concentrations of PPCP/NP wastes in the injection fluid as injected at the injection well. For example, if ibuprofen molecules are identified and measured in fluids injected into the subterranean formation at injector 1 (injection well) and in fluids produced from producer 2 (production well not the injection well), the presence of water channeling between injector 1 and producer 2 may be established or inferred. In implementations of this example, a pathway or water channeling between injector 1 and producer 2 can be unambiguously inferred if: (1) no ibuprofen were found from producer 2 before any PPCP were injected in injector 1, and (2) trace or any concentration (e.g., at least 0.1 ng/L) of ibuprofen were detected from producer 2 after PPCP (including ibuprofen) were injected in injector 1. The time for breakthrough or detection at the producer 2 may take some time (e.g., a day or few days) after the PPCP is injected at injector 1. Typical tracer techniques involving breakthrough may be utilized for the PPCP/NP wastes as interwell tracers. Tracer-response curves may be generated in the determination of water channeling or a subterranean path between the injector 1 and producer 2. Numerical simulation or reservoir models may be fitted to the observed response curves to further the analysis.

Some PPCP waste molecules may degrade in the presence of minerals in a subterranean formation. For instance, some PPCP (e.g., diclofenac, metoprolol, propranolol) may degrade in the presence of minerals such as manganese (IV) and iron (III) under anaerobic conditions expected in a hydrocarbon reservoir. See Liu, et al., Biological regeneration of manganese (IV) and iron (III) for anaerobic metal oxide-mediated removal of pharmaceuticals from water, Chemosphere, vol. 208, pp. 122-130 (October 2018). Some PPCP waste molecules may be differentially catalyzed in the presence of clays. For instance, ibuprofen may degrade (e.g., abiotic degradation pathways) by the presence of clay minerals, such as kaolinite clay. See Rubasinghege, et al., Abiotic Degradation and Environmental Toxicity of Ibuprofen: Roles of Mineral Particles and Solar Radiation, Water Research, vol. 131, pp. 22-32 (March 2018).

These properties of particular PPCP degraded or differentially catalyzed can be utilized to design “mineralogy tracers.” That is, by comparing the PPCP waste molecules before injection and after injection (as produced) to detect if the PPCP are degraded or catalyzed to form other molecules, the technique can determine if the PPCP waste contacted specific minerals in the subterranean formation.

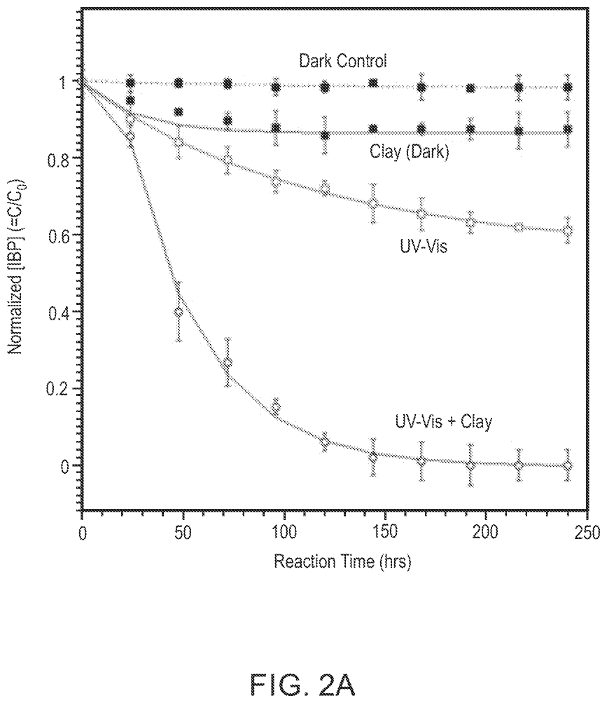

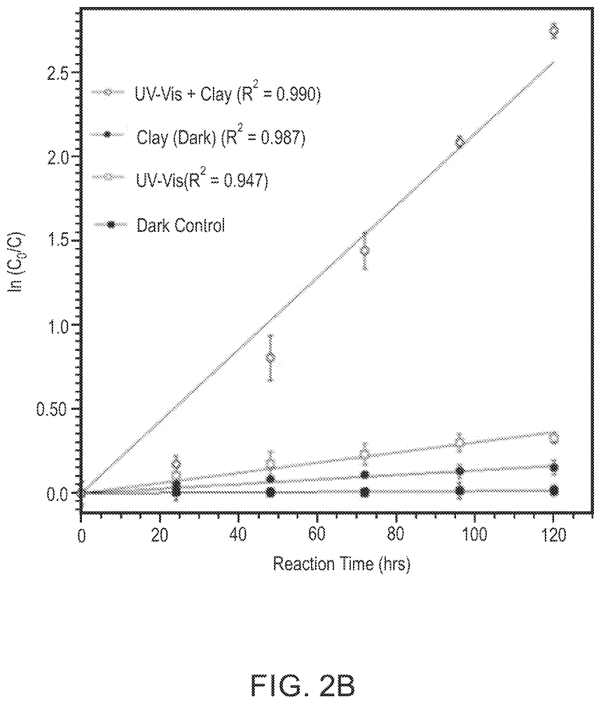

FIGS. 2A and 2B are plots related to ibuprofen decay, as given in the cited Rubasinghege, et al. article. FIG. 2A is a plot of normalized ibuprofen concentration [IBP] over the reaction time (hours). The normalized ibuprofen concentration [IBP] is the ratio of ibuprofen concentration (C) at reaction time to initial ibuprofen concentration (Cₒ). FIG. 2B is a plot of the natural logarithm of the normalized ibuprofen concentration over the reaction time. The two plots give a comparison of kinetics of ibuprofen decay (under experimental conditions) as determined from HPLC analysis of remaining ibuprofen in degraded samples. In the plot of FIG. 2A, the degradation rates of ibuprofen vary significantly with experimental condition. The degradation kinetics of ibuprofen, assuming pseudo-first order decay, is shown in the plot of FIG. 2B. The initial rates of degradation (r), determined from linear regression (time<50 hours), rate constants (k), and correlation coefficients (R²) is considered. The rate of ibuprofen decay in the presence of clay particles is faster and more extensive compared without clay. Under dark conditions, no decay was observed without clay (dark control). Under dark conditions with clay, decay was observed.

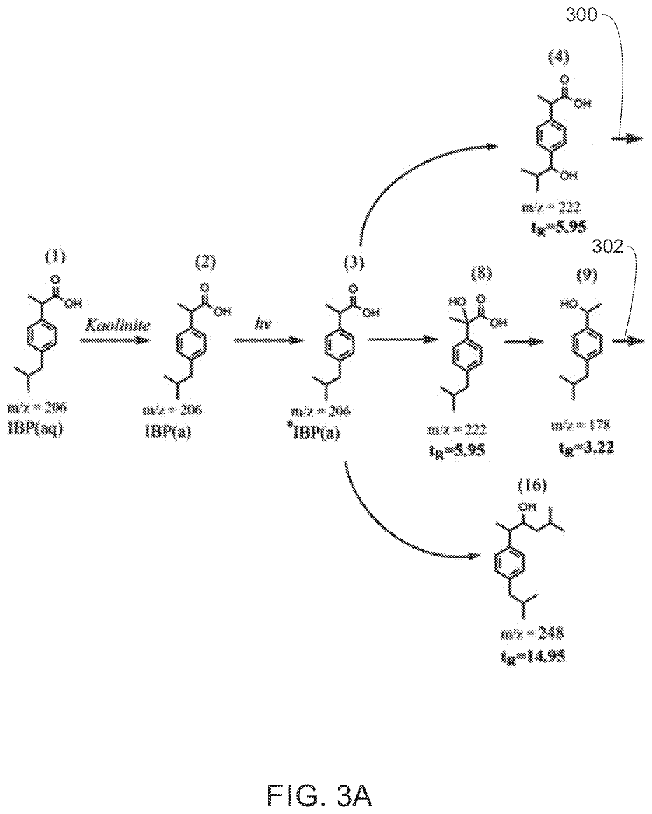

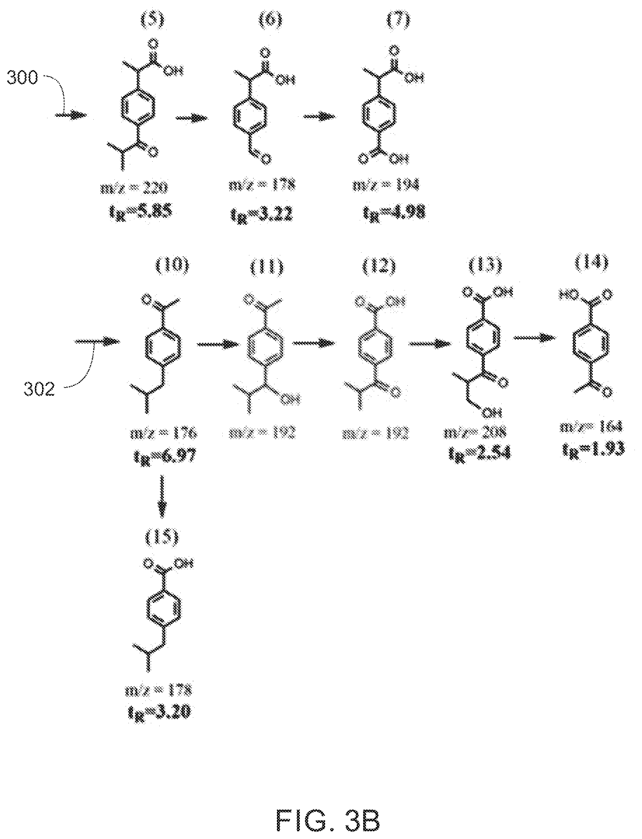

FIGS. 3A and 3B is reaction mechanisms, as provided in the cited Rubasinghege, et al. article, for the abiotic degradation of ibuprofen in the presence of kaolinite clay and light. FIG. 3B is a continuation of FIG. 3A, as indicated by reference numerals 300 and 302. Three reaction pathways are given based on the identified secondary products and their variations during the reaction time. The IBP(aq) is an aqueous solution of ibuprofen (IBP) in water. The IBP(a) is the aqueous solution with kaolinite clay applied (added). The *IBP(a) is after application of light (hv) to the aqueous solution of IBP having the kaolinite clay. The m/z is the mass-to-charge ratio associated with mass spectrometry. The tR is the retention time in minutes as measured from high-performance liquid chromatography (HPLC).

The reaction mechanisms without light may be different than depicted. The reaction mechanisms may also be affected in high-temperature high-pressure reservoir condition with clay, which may aid identifying the presence or absence of clays in reservoirs.

FIG. 4 is a workflow 400 for utilizing PPCP/NP wastes in water as interwell tracers. The workflow 400 may be similar to the workflow 100 of FIG. 1 but with additional actions related to the addition of foreign PPCP/NP in block 404.

At block 402, the workflow includes analyzing injection fluids for PPCP/NP waste to determine (measure) concentrations of PPCP/NP waste in the injection fluids. Such may be analogous (e.g., the same) as block 102 of FIG. 1. The injection fluids are fluids for injection through a wellbore into a subterranean formation. The injection fluids may be primarily water that may include seawater, groundwater, river water, or other water. In examples, the injection fluids may be fluids injected for waterflooding, such as in EOR.

At block 404, the workflow includes obtaining and recognizing foreign PPCP/NP as applicable as interwell tracers, and adding the foreign PPCP/NP to the injection fluid. The PPCP/NP may be foreign PPCP/NP in the sense that the PPCP/NP is not present in the injection fluid. The foreign PPCP/NP is not present in the injection fluid until added to (or otherwise co-injected with) the injection fluid. The workflow at block 404 may involve pre-screening of foreign PPCP/NP (originally not existing in the injection fluids) and adding the selected foreign PPCP/NP to the injection fluid so to be co-injected with the injection fluid. The pre-screening may be evaluation of applicability of the particular PPCP/NP as an interwell tracer. The screening standard may be similar with typical tracers, which can include consideration of thermal stability, low retention to reservoir rocks, oil partitioning coefficients, costs for sourcing materials, etc. After identified, the desired PPCP/NP (e.g., thermally stable, non-retentive, no or little partitioning to oil phase, and relatively inexpensive) that do not originally exist in the injection fluids as analyzed in block 402, may be mixed with the injection fluids at the injectors (injection wells) in preparation for block 406. The concentration of the added foreign PPCP/NP in the injection fluid may be specified and documented. The concentration as specified may be achieved by adding a specified amount of the foreign PPCP/NP to the injection fluid. The concentration of the added foreign PPCP/NP in the injection fluid may be confirmed (measured) via the analytical techniques mentioned with respect to block 102 of FIG. 1.

At block 406, the workflow includes injecting the injection fluid (having the added foreign PPCP/NP) into the subterranean formation, such as at an injection well having a wellbore in the subterranean formation for injection. Block 406 may be analogous to block 104 of FIG. 1 but with the injection fluid having the addition of foreign PPCP/NP from block 404. As discussed, the injection fluid may be primarily water and have the foreign PPCP/NP as identified and their concentration documented in block 404. The injection fluid may be injected for an interwell tracer test alone, or for waterflooding or other operations in which the interwell tracer test may be perform contemporaneously without affecting or interrupting the waterflooding or other operations.

At block 408, the workflow includes analyzing concentrations of the foreign PPCP/NP in production fluids and such correlated to the concentrations of the foreign PPCP/NP in the injection fluids. Block 408 may be analogous to block 106 of FIG. 1 but with the analysis of foreign PPCP/NP and not original PPCP/NP. Produced water (e.g., samples collected at discharge of production well) may be analyzed to determine traces (identity and concentrations) of the foreign PPCP/NP wastes and this correlated with the identification and concentrations of the foreign PPCP/NP wastes in the injection fluid as added and injected at the injection well. As discussed with respect to block 106 of FIG. 1, typical tracer techniques involving breakthrough may be utilized for the foreign PPCP/NP wastes as interwell tracers. Tracer-response curves may be generated in the determination of water channeling or a subterranean path, for example, between the injection well and one or more producers (production wells).

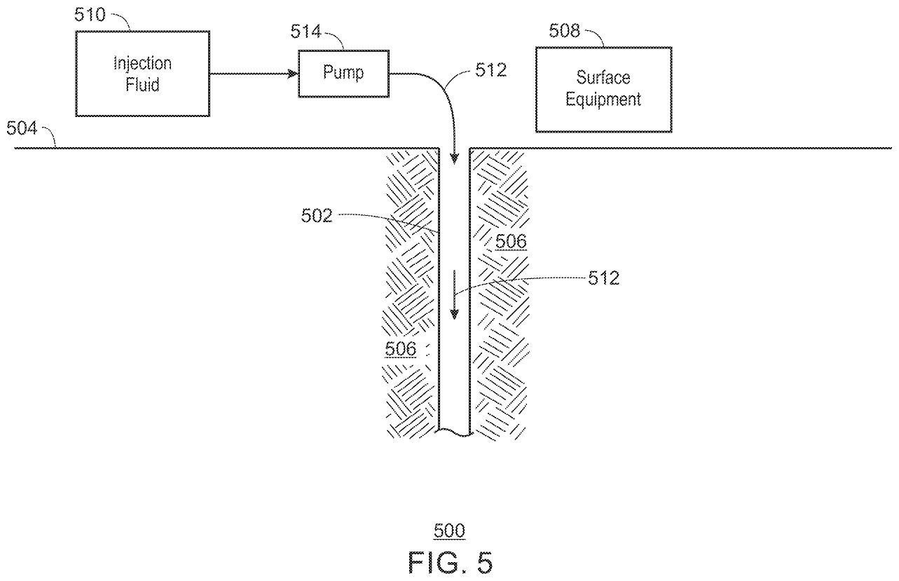

FIG. 5 is an injection well 500 (injector) having a wellbore 502 formed through the Earth surface 504 into a subterranean formation 506 in the Earth crust. The subterranean formation 506 may be labeled as a geological formation, reservoir formation, reservoir, hydrocarbon reservoir, oil reservoir, rock formation, hydrocarbon formation, and the like. Hydrocarbons in the subterranean formation may include crude oil or natural gas, or both. The wellbore 502 can be vertical, horizontal, or deviated. The wellbore 502 can be openhole but is generally a cased wellbore. The annulus between the casing and the formation 506 may be cemented. Perforations may be formed through the casing and cement into the formation 506. The perforations may allow both for flow of fluid (e.g., injection fluid) into the subterranean formation 506 and for flow of fluid (e.g., produced fluid) from the subterranean formation 506 into the wellbore 502. The surface equipment 508 may include equipment to support the injection of fluid into the subterranean formation 508 and the production of fluid from the subterranean formation 506.

As indicated, the well 500 may be configured and operated as an injection well. The well 500 sited may include a source 510 of injection fluid 512 at the Earth surface 504 near or adjacent the wellbore 502. The source 510 may include one or more vessels holding the injection fluid 512. The injection fluid 512 may be held in vessels or containers on ground, on a vehicle (for example, truck or trailer), or skid-mounted. The injection fluid 512 may be, for example, water-based or primarily water. The injection fluid 512 can include seawater, groundwater, river water, lake water, and so on. The injection fluid 512 can include PPCP/NP waste, which can be identified and with the concentration in the injection fluid 512 determined (measured). The PPCP/NP waster can act as an interwell tracer. The injection fluid 512 can include additives for oilfield operations such as for EOR waterflooding. The additives may include polymer, nanoparticles, etc. for the flooding.

The well 500 site may include motive devices such as one or more pumps 514 to pump (inject) the injection fluid 512 through the wellbore 502 into the subterranean formation 506. The pumps 514 may be, for example, positive displacement pumps and arranged in series or parallel. Again, the wellbore 502 may be a cemented cased wellbore and have perforations for the injection fluid 512 to flow (injected) into the formation 506. In some implementations, the speed of the pumps 514 may be controlled to give desired flow rate of the injection fluid 512. The system may include a control device to modulate or maintain the flow of injection fluid 512 into the wellbore 502 for the hydraulic fracturing. The control device may be, for example, a control valve(s). In certain implementations, as indicated, the control device may be the pump(s) 514 as a metering pump in which speed of the pump 514 is controlled to give the desired or specified flow rate of the injection fluid 512. The set point of the control device may be manually set or driven by a control system.

The pump 514 may be operationally coupled to the source 510 to provide the injection fluid 512 through the wellbore 502 into the subterranean formation 506, such as for EOR operations (e.g., waterflooding) or other operations. The injection fluid 512 may be prepared (formulated and mixed) offsite prior to disposition of the fracturing fluid 512 into the source 510 vessel at the well 500 site. A portion (some components) of the fracturing fluid 512 may be mixed offsite and disposed into the source 510 vessel and the remaining portion (remaining components) of the injection fluid 512 added to the source 510 vessel or to a conduit conveying the injection fluid 512. The injection fluid 512 may be prepared onsite with components added to (and batch mixed in) the source 510 vessel. Components may be added online to the source 510 vessel or to a conduit conveying the injection fluid 512 during the injection. As mentioned, polymer or nanoparticles are examples of components (additives) that may incorporate with the injection fluid 512 for the injection. Also, foreign PPCP/NP may be added to the injection fluid 512. See, for example, block 404 of FIG. 4.

In particular implementations, the injection system parameters adjusted may include at least pump(s) 514 rate, component (additive) concentrations in the fracturing fluid 512, and any on-line component addition rates (if implemented) to the fracturing fluid 512. Injection operations can be manual or guided with controllers. The well 500 site may include a control system that supports or is a part of the injection system.

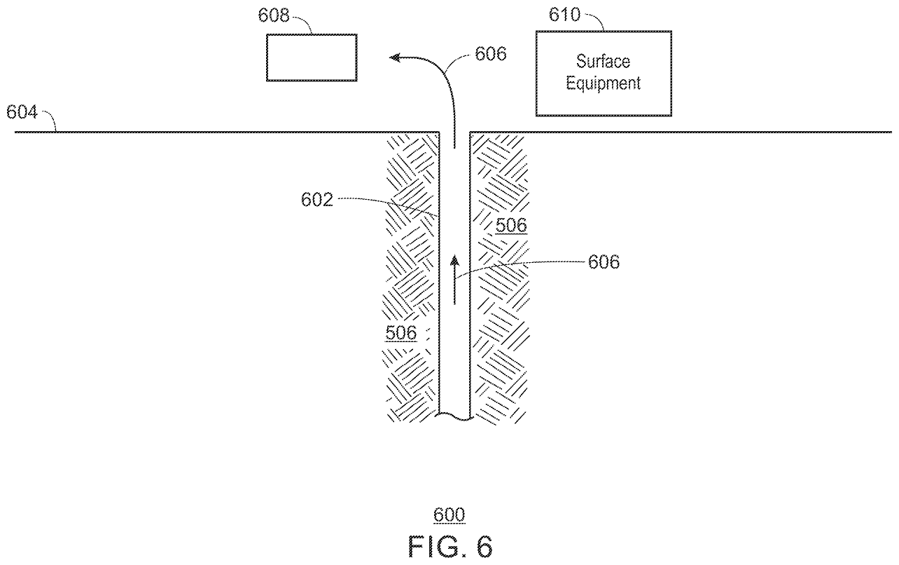

FIG. 6 is a production well 600 (producer) having a wellbore 602 formed through the Earth surface 604 into the subterranean formation 506. The production well 600 may be nearby an injection well, such as the injection well 500 of FIG. 5. The production well 600 may receive and discharge production fluids (e.g., produced fluid 606) from the subterranean formation 506. The produced fluid 606 may discharge through a wellhead and conduits at the surface 604, as indicated by reference numeral 608. The produced fluid 606 (e.g., primarily water in certain instances) may be analyzed to measure concentration(s) of PPCP/NP waste in the produced fluid 606. In implementations, a sample of the produced fluid 606 may be collected via the wellhead/conduits 608 at the surface 604 for the analysis.

The wellbore 602 can be vertical, horizontal, or deviated. The wellbore 602 can be openhole but is generally a cased wellbore. The annulus between the casing and the formation 506 may be cemented. Perforations may be formed through the casing and cement into the formation 506. The perforations may allow both for flow of fluid (e.g., produced fluid 606) from the subterranean formation 506 into the wellbore 602 and for flow of fluid into the subterranean formation 506 from the wellbore 602. The surface equipment 610 may include equipment to support the production of fluid 606 from the subterranean formation 506.

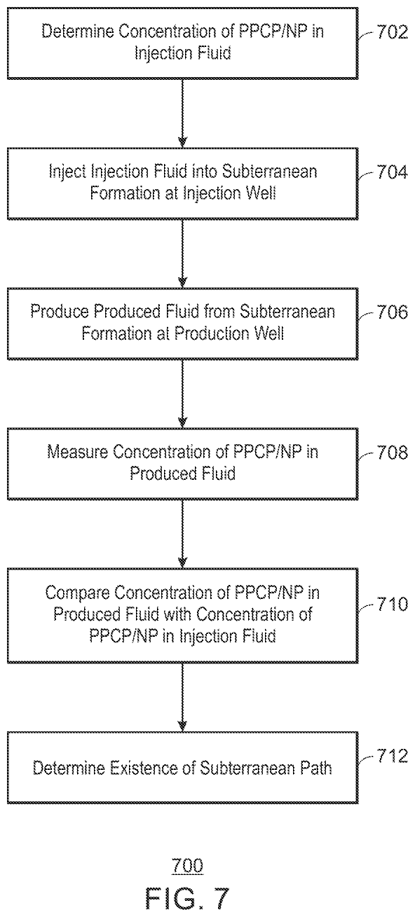

FIG. 7 is a method 700 of utilizing waste as an interwell tracer. PPCP/NP waste existing in injection fluid may be utilized as an interwell tracer. Foreign PPCP/NP may be added to the injection fluid as the waste utilized as the interwell tracer. In some implementation, the waste may act as interwell tracer that is a mineralogy tracer.

At block 702, the method includes determining concentration of waste in injection fluid to be injected. The waste is PPCP (PPCP waste) or NP (NP waste), or both. The injection fluid includes water. The injection fluid may be injection water. The determining of the concentration of the waste in the injection fluid may be measuring the concentration of the waste in the injection fluid. The water in the injection fluid may be seawater, groundwater, river water, lake water, or any combinations thereof.

The NP may be, for example, PET, PE, HDPE, LDPE, PP, PS, PVC, or polyurethane, or any combinations thereof. The PPCP may be, for example, sulfamethoxazole, sulfamethazine, ofloxacin, norfloxacin, azithromycin, trimethoprim, ibuprofen, naproxen, diclofenac, salicylic acid, bezafibrate, gemfibrozil, clofibric acid, carbamazepine, diazepam, prim idone, caffeine, diethyltoluamide (DEET), Iopamidol, propranolol, metoprolol, galazolide, tonalide, octocrylene, ethylhexyl methoxycinnamate, 1H-benotriazole, atenolol, atrazine, benzoylecgonine, cetirizine, citalopram, clarithromycin, desethylatrazine, diuron, erythromycin, fluoxetine, gembifrozil, haloperidol, iohexol, iopamidol, isoproturon, loratadine, mecoprop, paracetamol, paraxanthine, roxithromycin, sotabol, tamoxifen, terbuthylazine, theobromine, theophylline, or tolytriazole, or any combinations thereof.

For the waste as PPCP, the determining of the concentration of the PPCP waste or NP waste in the injection water may involve measuring the concentration of the PPCP waste or NP waste in the injection water. For example, the PPCP concentration in the injection water may be measured via SPE, GC-MS, or HPLC, or any combinations thereof. The NP concentration in the injection water may be measured, for example, via UV-VIS spectroscopy, FFF, or Pyrolysis-MS, or any combinations thereof.

The method may include adding the waste (e.g., foreign PPCP/NP) to the injection fluid that is not originally in the injection fluid. In implementations, the determining of the concentration of the waste in the injection fluid may involve specifying an amount of the waste added to the injection fluid.

At block 704, the method includes injecting the injection fluid (e.g., injection water) at an injection well (injector) into a subterranean formation. The injecting may involve pumping (e.g., via a surface pump) the injection fluid from the Earth surface through a wellbore of the injection well into the subterranean formation.

The injecting of the injection fluid may be injecting the injection fluid as injection water at the injection well for an EOR operation. The injecting of the injection fluid may be injecting the injection fluid for the EOR operation and for performing contemporaneously interwell tracing via the waste as an interwell tracer.

In implementations, the injecting of the injection fluid may be injecting the injection fluid at the injection well for waterflooding the subterranean formation. The waterflooding is performed contemporaneous with interwell tracing via the waste as an interwell tracer. The injection fluid may include polymer in addition to the water for polymer flooding, and wherein the polymer is not the waste. The injection fluid may include nanoparticles in addition to the water for nanofluid flooding, and wherein the nanoparticles are not the waste.

At block 706, the method includes discharging production fluid from the subterranean formation at a production well (producer). In other words, the method may include producing produced fluid at a production well from the subterranean formation. The produced fluid includes water. The produced fluid may flow from the subterranean through the wellbore of the production well to the Earth surface. The produced fluid may discharge from the wellbore through, for example, a wellhead and conduits at the Earth surface.

At block 708, the method includes measuring concentration of the waste in the produced fluid. The method may include collecting a sample of the produced fluid for measurement. The sample may be collected at the Earth surface adjacent the wellbore of the production well. For example, the sample may be collected from a surface conduit conveying the produced fluid. The measuring of the concentration of the waste (PPCP/NP) in the produced fluid may be per the analytical techniques discussed with respect to block 702 for measuring concentration of the waste in the injection fluid.

At block 710, the method includes comparing or correlating the concentration of the waste in the produced fluid with the concentration of the waste in the injection fluid. The comparing or correlating may involve establishing tracer response curve(s) with the waste as an interwell tracer.

At block 712, the method includes determining or confirming via the comparing (or correlating) an existence of a subterranean path (flow path) in the subterranean formation between the injection well and the production well. The determination may involve further analysis of the tracer response curves, such as with applying numerical simulation or reservoir models to the observed response curves. The subterranean path may include water channeling. In other words, water channeling (flow of water) may be present in the subterranean flow path.

Lastly, the molecular structure of the PPCP (PPCP waste) may be altered by contact with a mineral in the subterranean formation. For example, the mineral may be clay, manganese (IV), or iron (III), or any combinations thereof. The method may include utilizing the PPCP (PPCP waste) as an interwell tracer comprising a mineralogy tracer. The altering of the PPCP due to contact of the PPCP with the mineral may involve degradation, decay, or differentially catalyzed. These response properties of the particular PPCP may give the PPCP as a mineralogy tracer in the PPCP molecules before injection and after injection (as produced) can be compared to detect if the PPCP contacted the minerals. Thus, presence of the mineral (potentially including along the determined subterranean flow path) in the subterranean formation may be confirmed.

A number of implementations have been described. Nevertheless, it will be understood that various modifications may be made without departing from the spirit and scope of the disclosure.

What is claimed is:

1. A method of utilizing waste as an interwell tracer, comprising:
determining concentration of waste in injection fluid, wherein the injection fluid comprises water, and wherein the waste comprises pharmaceutical, personal care product (PPCP) waste or nanoplastic (NP) waste, or both;
injecting the injection fluid at an injection well into a subterranean formation;
producing produced fluid at a production well from the subterranean formation, wherein the produced fluid comprises water;
measuring concentration of the waste in the produced fluid; and
comparing the concentration of the waste in the produced fluid with the concentration of the waste in the injection fluid.

2. The method of claim 1, comprising determining via the comparing an existence of a subterranean path in the subterranean formation between the injection well and the production well.

3. The method of claim 2, wherein the subterranean path comprises water channeling.

4. The method of claim 1, wherein injecting the injection fluid comprises injecting the injection fluid at the injection well for an enhanced oil recovery (EOR) operation.

5. The method of claim 4, wherein injecting the injection fluid comprises injecting the injection fluid for the EOR operation and for performing contemporaneously interwell tracing via the waste as an interwell tracer.

6. The method of claim 1, wherein injecting the injection fluid comprises injecting the injection fluid at the injection well for waterflooding the subterranean formation.

7. The method of claim 6, wherein the waterflooding is performed contemporaneous with interwell tracing via the waste as an interwell tracer.

8. The method of claim 6, wherein the injection fluid comprises polymer in addition to the water for polymer flooding, and wherein the polymer is not the waste.

9. The method of claim 6, wherein the injection fluid comprises nanoparticles in addition to the water for nanofluid flooding, and wherein the nanoparticles are not the waste.

10. The method of claim 1, wherein determining the concentration of the waste in injection fluid comprises measuring the concentration of the waste in the injection fluid, and wherein the water in the injection fluid comprises seawater, groundwater, river water, or lake water, or any combinations thereof.

11. The method of claim 1, wherein the waste comprises PPCP waste.

12. The method of claim 11, wherein determining the concentration of the PPCP waste in the injection fluid comprises measuring the concentration of the PPCP waste in the injection fluid utilizing ultraviolet-visible (UV-VIS) spectroscopy, pyrolysis mass spectrometry (Pyrolysis-MS), or field flow fractionation (FFF), or any combinations thereof.

13. The method of claim 11, wherein molecular structure of the PPCP waste is altered by contact with a mineral in the subterranean formation.

14. The method of claim 13, comprising utilizing the PPCP waste as an interwell tracer comprising a mineralogy tracer.

15. The method of claim 13, wherein the mineral comprise clay, manganese (IV), or iron (III), or any combinations thereof.

16. The method of claim 1, comprising adding the waste to the injection fluid, wherein determining the concentration of the waste comprises specifying an amount of the waste added to the injection fluid.

17. A method of utilizing waste as an interwell tracer, comprising:
measuring concentration of the waste in injection water, wherein the waste comprises pharmaceutical, personal care product (PPCP) or nanoplastic (NP), or both;
injecting the injection water into a subterranean formation at an injection well;
producing water from the subterranean formation at a production well;
measuring concentration of the waste in the water as produced; and
correlating the concentration of the waste in the water as produced with the concentration of the waste in the injection water.

18. The method of claim 17, comprising confirming via the correlating an existence of a subterranean path in the subterranean formation between the injection well and the production well.

19. The method of claim 17, wherein the waste comprises NP, and wherein the NP comprises polyethylene terephthalate (PET), polyethylene (PE), high-density polyethylene (HDPE), low-density polyethylene (LDPE), polypropylene (PP), polystyrene (PS), polyvinyl chloride (PVC), or polyurethane, or any combinations thereof.

20. The method of claim 17, wherein the waste comprises PPCP.

21. The method of claim 20, wherein the PPCP comprises sulfamethoxazole, sulfamethazine, ofloxacin, norfloxacin, azithromycin, trimethoprim, ibuprofen, naproxen, diclofenac, salicylic acid, bezafibrate, gemfibrozil, clofibric acid, carbamazepine, diazepam, prim idone, caffeine, diethyltoluamide (DEET), lopam idol, propranolol, metoprolol, galazolide, tonalide, octocrylene, ethylhexyl methoxycinnamate, 1H-benotriazole, atenolol, atrazine, benzoylecgonine, cetirizine, citalopram, clarithromycin, desethylatrazine, diuron, erythromycin, fluoxetine, gembifrozil, haloperidol, iohexol, iopam idol, isoproturon, loratadine, mecoprop, paracetamol, paraxanthine, roxithromycin, sotabol, tamoxifen, terbuthylazine, theobromine, theophylline, or tolytriazole, or any combinations thereof.
